(19) United States
(12) Patent Application Publication
(10) Pub. No.: US 2023/0394287 A1
(43) Pub. Date: Dec. 7, 2023

(54) GENERAL MEDIA NEURAL NETWORK PREDICTOR AND A GENERATIVE MODEL INCLUDING SUCH A PREDICTOR

(71) Applicants: Dolby Laboratories Licensing Corporation, San Francisco, CA (US); DOLBY INTERNATIONAL AB, Dublin (IE)

(72) Inventors: Cong Zhou, Foster City, CA (US); Mark S. Vinton, Alameda, CA (US); Grant A. Davidson, Burlingame, CA (US); Lars Villemoes, Järfälla (SE)

(73) Assignees: Dolby Laboratories Licensing Corporation, San Francisco, CA (US); DOLBY INTERNATIONAL AB, Dublin (IE)

(21) Appl. No.: 18/248,805

(22) PCT Filed: Oct. 12, 2021
(86) PCT No.: PCT/US2021/054617

§ 371 Date: Apr. 12, 2023

Related U.S. Application Data
(60) Provisional application No. 63/092,552, filed on Oct. 16, 2020.

(30) Foreign Application Priority Data
Nov. 10, 2020 (EP) 20206729.4

(51) Int. Cl. G06N 3/0475; G06N 3/044; G06N 3/045

(52) U.S. Cl. CPC G06N 3/0475; G06N 3/044; G06N 3/045

(57) ABSTRACT

A neural network system for predicting frequency coefficients of a media signal, the neural network system comprising a time predicting portion including at least one neural network trained to predict a first set of output variables representing a specific frequency band of a current time frame given coefficients of one or several previous time frames, and a frequency predicting portion including a at least one neural network trained to predict a second set of output variables representing a specific frequency band given coefficients of one or several frequency bands adjacent to the specific frequency band in said current time frame. Such a neural network system forms a predictor capable of capturing both temporal and frequency dependencies occurring in time-frequency tiles of a media signal.

### CROSS REFERENCE TO RELATED APPLICATIONS

This application claims priority to U.S. provisional application 63/092,552, filed 16 Oct. 2020 and European Patent Application No. 20206729.4, filed 10 Nov. 2020, all of which are incorporated herein by reference in their entirety.

### FIELD OF THE INVENTION

The present invention relates to a generative model for media, in particular audio. Specifically, the present invention relates to computer implemented neural network system for predicting frequency coefficients representing frequency content of a media signal.

### BACKGROUND OF THE INVENTION

A generative model for high-quality media (and in particular audio) can enable many applications. Raw waveform generative models have been proven to successfully achieve high quality audio within certain signal categories e.g. speech and piano, but the quality for general audio is still lacking.

Recently attempts have been made to move away from the raw waveform domain, for example as discussed in the article “MelNet: A Generative Model for Audio in the Frequency Domain”, by Vasquez and Lewis, 2019.

Still, even further improvements would be beneficial.

### General Disclosure of the Invention

Based on the above, it is therefore an object of the present invention to provide an improved generative model for general media, and in particular general audio, i.e. not only specific categories of audio, like speech or piano music, but audio in general.

According to a first aspect of the present invention, this and other objects are achieved by a neural network system for predicting frequency coefficients of a media signal, the neural network system comprising a time predicting portion including at least one neural network trained to predict a first set of output variables representing a specific frequency band of a current time frame given coefficients of one or several previous time frames, and a frequency predicting portion including a at least one neural network trained to predict a second set of output variables representing a specific frequency band given coefficients of one or several frequency bands adjacent to the specific frequency band in said current time frame, and an output stage configured to provide a set of frequency coefficients representing said specific frequency band of said current time frame, based on said first and second set of output variables.

Such a neural network system forms a predictor capable of capturing both temporal and frequency dependencies occurring in time-frequency tiles of a media signal. The frequency predicting portion is designed to capture frequency dependency e.g. harmonic structures.

Such a predictor has shown promising results as a neural network decoder in audio coding applications. In addition, such neural network can be utilized in other signal processing applications such as bandwidth extension, packet loss concealment and speech enhancement.

The time and frequency based predictions may, in principle, be performed in any order, or even in combination. However, in a typical on-line application, with frame-by-frame processing, the time prediction would typically be performed first (on a number of previous frames), and the output of this prediction be used in the frequency prediction.

According to one embodiment, the time predicting portion includes a time predicting recurrent neural network comprising a plurality of neural network layers, said time predicting recurrent neural network being trained to predict an intermediate set of output variables representing the current time frame, given a first set of input variables representing a preceding time frame of the media signal.

Similarly, according to some embodiments, the frequency predicting portion includes a frequency predicting recurrent neural network comprising a plurality of neural network layers, said frequency predicting neural network being trained to predict said second set of output variables, given a sum of said first set of output variables and a second set of input variables representing lower frequency bands of the current time frame.

Recurrent neural networks have shown especially useful in this context.

The time predicting portion may also be a band mixing neural network trained to predict said first set of output variables, wherein variables in the intermediate set are formed by mixing variables in said intermediate set representing said specific frequency band and a plurality of neighboring frequency bands.

Such a band mixing neural network performs cross-band prediction, thereby avoiding (or at least reducing) aliasing distortion

Each frequency coefficient may be represented by a set of distribution parameters, wherein said set of distribution parameters are configured to parametrize a probability distribution of the coefficient. The probability distribution may be one of a Laplace distribution, a Gaussian distribution, and a Logistic distribution.

A second aspect of the present invention relates to a generative model for generating a target media signal, comprising a neural network system according to the first aspect, and a conditioning neural network configured to predict a set of conditioning variables given conditioning information describing the target media signal.

In the case where the time predicting portion includes a time predicting recurrent neural network, the time predicting recurrent neural network can be configured to combine said first set of input variables with at least a subset of said set of conditioning variables.

In the case where the frequency predicting portion includes a frequency predicting recurrent neural network, the frequency predicting recurrent neural network can be configured to combine said sum with at least a subset of said set of conditioning variables.

The conditioning information may include quantized (or otherwise distorted) frequency coefficients, thereby allowing the neural network system to predict a dequantized (or otherwise enhanced) frequency coefficients representing the media signal.

In some applications, e.g. in a neural network-based decoder in a general audio codec, the quantized frequency coefficients may be combined with a set of perceptual model coefficients, derived from a perceptual model. Such conditioning information may further improve the prediction.

In empirical studies, such a generative model has been implemented in a general audio coding application, so that it receives quantized MDCT bins as input and predicts dequantized MDCT bins. It has been showed that spectral holes are filled with plausible structures and quantization errors are cleaned up in the predictions. In a MUSHRA-style subjective assessment of a “deep audio codec” using a generative model according to the second aspect of the invention operating at 20 kb/s, in comparison with several prior-art codecs at different bitrates, the “deep audio codec” was rated on-par overall with an MPEG-4 AAC codec at 32 kb/s. This represents a bitrate saving of 37%.

A third aspect of the present invention relates to a method for inferencing an enhanced media signal using a generative model according to the second aspect of the invention.

A fourth aspect of the present invention relates to a method for training the neural network system according to the first aspect of the invention.

### BRIEF DESCRIPTION OF THE DRAWINGS

The present invention will be described in more detail with reference to the appended drawings, showing currently preferred embodiments of the invention.

FIG. 1a-b show a high-level structure of a time/frequency predictor according to embodiments of the present invention.

FIG. 2 shows a neural network system implementing the structure in FIG. 1a.

FIG. 3 shows the neural network system in FIG. 2, operating in self-generation mode.

FIG. 4 shows a generative model including the neural network in FIG. 2.

### DETAILED DESCRIPTION OF PREFERRED EMBODIMENTS

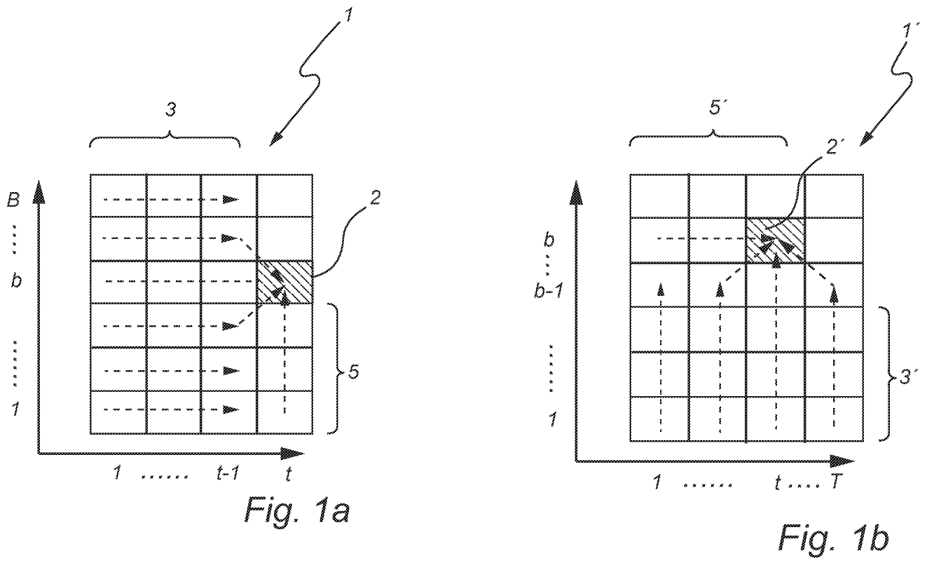

FIGS. 1a and 1b schematically illustrate two examples of a high-level structure of a time/frequency predictor 1 according to an embodiment of the present invention. The predictor operates on frequency coefficients representing frequency content of a media (e.g. audio) signal. The frequency coefficients may correspond to bins of a time-to-frequency transform of the media signal, such as a Discrete Cosine Transform (DCT) or a Modified Discrete Cosine Transform (MDCT). Alternatively, the frequency coefficients may correspond to samples of a filterbank representation of the media signal, for example a Quadrature Mirror Filter (QMF) filterbank.

In FIG. 1a, the frequency coefficients (here sometimes referred to as “bins”) of previous time frames are first grouped into a preselected number B of frequency bands. Then the predictor 1 predicts bins 2 of a target band b in a current time frame t based on the band context collected from all previous time frames 3. The predictor 1 then predicts bins 2 of the target band b based on all lower and N higher bands (i.e. bands 1 . . . b+N), where N is between 1 and B-b. In FIG. 1a, N is equal to 1, i.e. only one higher band b+1 is taken into account. Finally, the predictor predicts bins 2 in the target band b based on all lower (previously predicted) frequency bands 5 in the current time frame t.

The joint probability density of frequency coefficients (e.g. MDCT bins) Xₜ(b) can be expressed as a product of conditional probabilities:

$$p ( X ) = {\prod }_{b} {\prod }_{t} p ( {X}_{t} ( b ) \vert {X}_{1 … t - 1} ( 1 … b + N ) , {X}_{t} ( 1 … b - 1 ) ) , \qquad ( 1 )$$

where Xₜ(b) represents the group of coefficients in band b at time t, N represents the number of neighboring adjacent bands on each side (higher and lower), X_{1 . . . t-1} (1 . . . b+N) represents coefficients in bands 1 to b+N from time 1 to time t−1, and finally Xₜ(1 . . . b−1) represents the bins in band 1 to band b−1 at time t.

As clear from the above description of the predictor in FIG. 1a, the prediction is done first in the time dimension and then in the frequency dimension. This is quite normal in many applications, e.g. in an audio decoder, where the prediction is typically made in real-time of the next frame of a signal.

Generally speaking, however, for example if an entire signal is available off-line, the time/frequency predictor could operate in the opposite order. This, slightly less intuitive, process is illustrated in FIG. 1b.

Here, first the bins in each lower band are grouped into a set of T time frames. Then, the predictor 1′ predicts the bins 2′ of a target frame t in the current (next higher) frequency band b based on the band context collected from all lower frequency bands 3′. The predictor 1′ then predicts bins 2′ of the target frame t based on the lower frequency bands in all preceding and N subsequent (future) time frames (i.e. frames 1 . . . t+1), where N here is between 1 and T−t. In FIG. 1b, N is again equal to 1, i.e. one subsequent (future) frame is taken into account. Finally, the predictor predicts the bins 2′ in the target frame t based on all preceding (previously predicted) time frames 5′ in the current frequency band b.

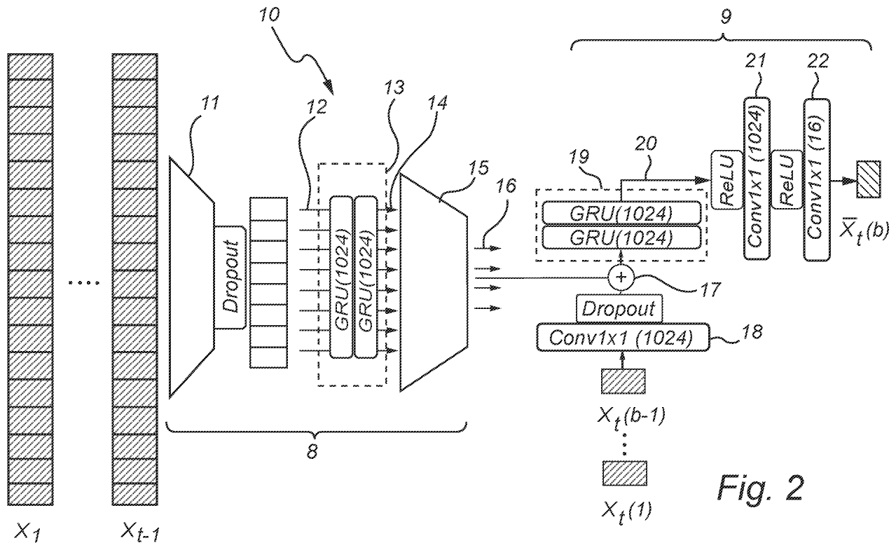

An example implementation of the predictor in FIG. 1a in a neural network system 10 is illustrated as a block diagram in FIG. 2. As explained in detail in the following, the network system 10 has a time predicting portion 8 and a frequency predicting portion 9.

In the time predicting portion 8, a convolution network 11 receives frequency transform coefficients (bins) of a previous frame Xₜ₋₁ and performs convolution of the frequency bins to group them into B bands 12. As an example, B is equal to 32. In one implementation, the convolution network 11 is implemented as a convolution layer having a kernel length, K, equal to 16 and a stride, S, equal to 8 (i.e. 50% overlap).

The bands 12 are fed into a time predicting recurrent neural network (RNN) 13 containing a set of recurrent layers, here in the form of Gated Recurrent Units (GRU). Other recurrent neural networks may also be used, such as Long short-term memories (LSTM), Quasi-Recurrent Neural Networks (QRNN), Bidirectional recurrent units, Continuous time recurrent networks (CTRNN), etc. The network 13 processes the B bands separately but with shared weights, obtaining individual hidden states 14 for each frequency band of the current (predicted) time frame. Each hidden state 14 includes a set of output variables, wherein the size of the set is determined by the internal dimension of the layers in the RNN 13. In the illustrated example, the internal dimension is 1024, so there are 1024 variables representing each frequency band of the current (predicted) time frame. With B=32, there are thus 32×1024 variables output from the RNN 13.

The B hidden states 14 are then fed to another convolutional network 15 which mixes the variables of all lower and N higher bands (i.e. neighboring hidden states) in order to achieve a cross-band prediction p(Xₜ(b)|X_{1 . . . t-1}(1 . . . b+N)). In one implementation, the convolutional network 15 is implemented as a single convolution layer along the band dimension, where the kernel length is 2N+1, with N lower bands and N higher bands. In another implementation, the convolution layer kernel length is N+2 with one lower band and N higher bands. The output (hidden state) 16 is again B sets of output variables, where the size of each set is determined by the internal dimension. In the present case, again 32×1024 variables are output from the network 15.

In the frequency predicting portion 9, the hidden state 16 representing the current (predicted) time frame is fed to a summation point 17. A 1×1 convolution layer 18 receives frequency coefficients of previous bands Xₜ(1) . . . Xₜ(b−1), and projects them onto the internal dimension of the system, i.e. 1024 in the present case.

The output pf the summation point 17 is fed into a recurrent neural network (RNN) 19 containing a set of recurrent layers, here in the form of Gated Recurrent Units (GRU). Again, other recurrent neural networks may also be used, such as Long short-term memories (LSTM), Quasi-Recurrent Neural Networks (QRNN), Bidirectional recurrent units, Continuous time recurrent networks (CTRNN), etc. The RNN 19 takes the summation output and predicts a set of output variables (hidden state) 20 representing Xₜ(b). Finally, two output layers 21, 22 in the form of two 1×1 convolution layers (output dimension 1024 and 16, respectively), with ReLU activation preceding each convolutional layer, serve to provide the final prediction of Xₜ(b), according to the final prediction scheme p(Xₜ(b)|X_{1 . . . t-1} (1 . . . b+N), Xₜ(1 . . . b−1)). The hidden state 20 of RNN 19 is reset for every new time stamp.

In one embodiment, each frequency coefficient is represented by two parameters, for example the system may predict the parameters μ (location) and s (scale) of a Laplace distribution. In one implementation, log (s) is used instead of s for computational stability. In other implementation, a Logistic distribution or a Gaussian distribution can be chosen as the target distribution for parameterization. The output dimension of the final output layer 22, is therefore twice the number of bins. In the present case, the output dimension of layer 22 is 16, corresponding to eight bins in each frequency band.

In another embodiment, the frequency coefficients are parametrized as a mix of distributions, where each parametrized distribution has an individual (normalized) weight. Each coefficient will then be represented by (number of distributions) x (number of distribution parameters+1) parameters. For example, in the specific case of mixing two Laplace distributions (each with two parameters), each coefficient will be represented by 2×(2+1)=6 parameters (two sets of weights (w1 and w2), location (u1, u2), and scale (s1, s2), where w1+w2=1). The output dimension of the output layer 22 will then be 8×6=48. The previously mentioned embodiment is a special case with only one distribution and weight equal to one.

With reference to FIG. 5, training of the neural network system 10 can be done in “teacher forcing mode”. First, in step S1, ground truth frequency coefficients representing an “actual” (known) media signal are provided to the convolution network 11 and to the convolution layer 18, respectively. The probability distributions of the bins X̅ₜ(b) of a current time frame are then predicted in step S2. In step S3, the predicted bins X̅ₜ(b) are compared to the actual bins Xₜ(b) of the actual signal in order to determine a training measure. Finally, in step S4, the parameters (weights and bias) of the various neural networks 11, 13, 15, 18, 19, 21, 22 are chosen such that the training measure is minimized. As an example, the training measure which should be minimized may be the negative log-likelihood (NLL), e.g. in the case of Laplace distribution:

$$N L L = log ( 2 * s ) + \frac{\vert μ - y \vert}{s} , \qquad ( 2 )$$

where μ and s are the model output predictions and y is the actual bin value. The NLL would look slightly different in case of a Gaussian or mixture distribution model.

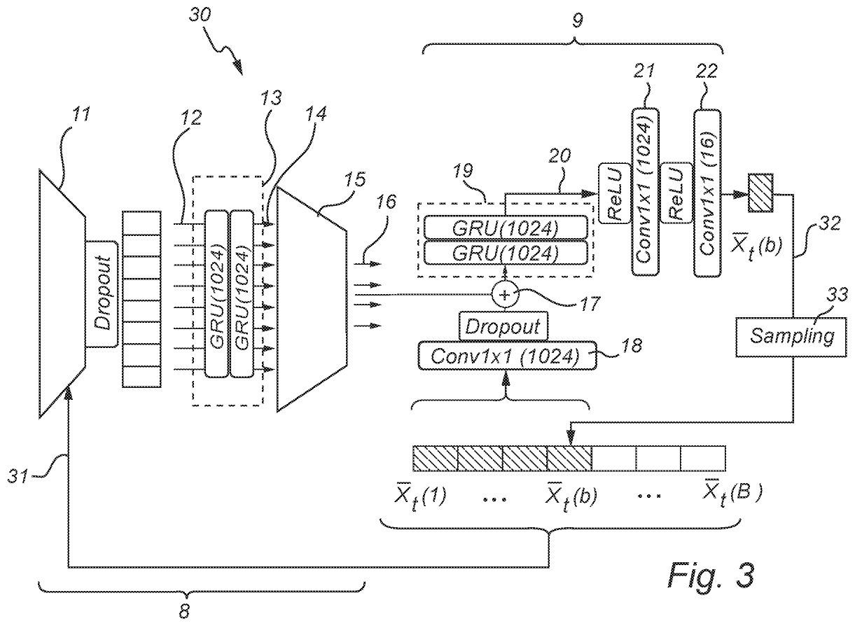

FIG. 3 illustrates the neural network system 10 in FIG. 2 in an inferencing mode, also known as a “self-generation” mode, wherein a predicted X t (b) is used as history to continuously generate new predictions. The neural network system in FIG. 3 is referred to as a self-generating predictor 30. Such a predictor can be used in an encoder to compute a prediction error based on a prediction generated by the predictor. The prediction error can be quantized and included in the bitstream as a residual error. In the decoder, the predicted result can then be added to the quantized error to obtain a final result.

The predictor 30 here includes two feedback paths, 31, 32; a first feedback path 31 for the time predicting portion 8 of the system, and a second feedback path 32 for the frequency predicting portion 9 of the system.

More specifically, a predicted X̅ₜ(b) is added to a partially predicted current frame X̅ₜ so that it then includes bands X̅ₜ(1)−X̅ₜ(b). These bands are provided as input to the convolutional network 18, and then to summation point 17, in order to predict the next higher band, X̅ₜ(b+1). When all bands in the current frame X̅ₜ have been predicted, this entire frame is provided as input to the convolutional net 11, to enable prediction of the next time frame X̅ₜ₊₁.

Given that μ and s are the predicted parameters from the proposed neural network, a sampling operation 33 is required to obtain predicted bin values. The sampling operation can be written as:

X̅=μ+F(u,s) (3)

where X is predicted bin value, F( ) is the sampling function determined by pre-chosen distribution and u is a random sample from uniform distribution. For example, in a Laplace distribution case,

F=−s*sign(u)*log(1-2*|u|),u˜U(−0.5,0.5) (4)

To reduce accumulation of sampling error, F( ) may be adapted with “truncation” and “temperature” (e.g. weighting on s). In one implementation, “truncation” is done by sampling u˜U(−0.49, 0.49) which bounds sampling output to (μ−4*s, μ+4*s). In another embodiment, μ is taken directly (max sampling). The “temperature” may be done by multiplying weight w on s, and in one implementation the weight w can be controlled by prior knowledge about the target signal, including e.g. spectral envelope and band tonality.

The neural network system 10 embodies a predictor as shown in FIG. 1a, and may advantageously be conditioned by suitable conditioning signal, thereby forming a conditioned prediction:

$$p ( X ) = {\prod }_{b} {\prod }_{t} p ( {X}_{t} ( b ) \vert {X}_{1 … t - 1} ( 1 … b + N ) , {X}_{t} ( 1 … b - 1 ) , c ) \qquad ( 5 )$$

where c represents the conditioning signal, including e.g. quantized (or otherwise distorted) frequency coefficients \tilde{X}.

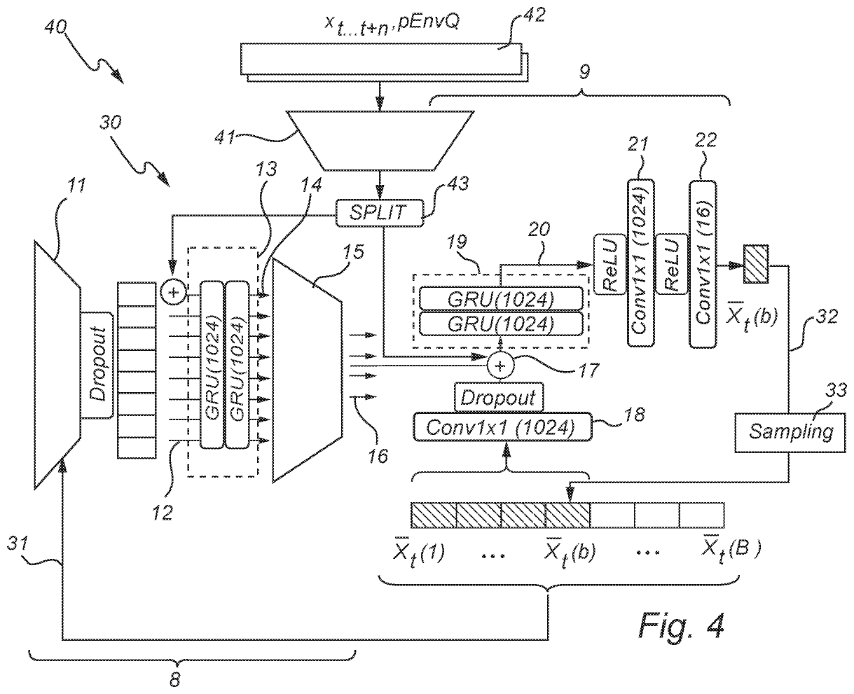

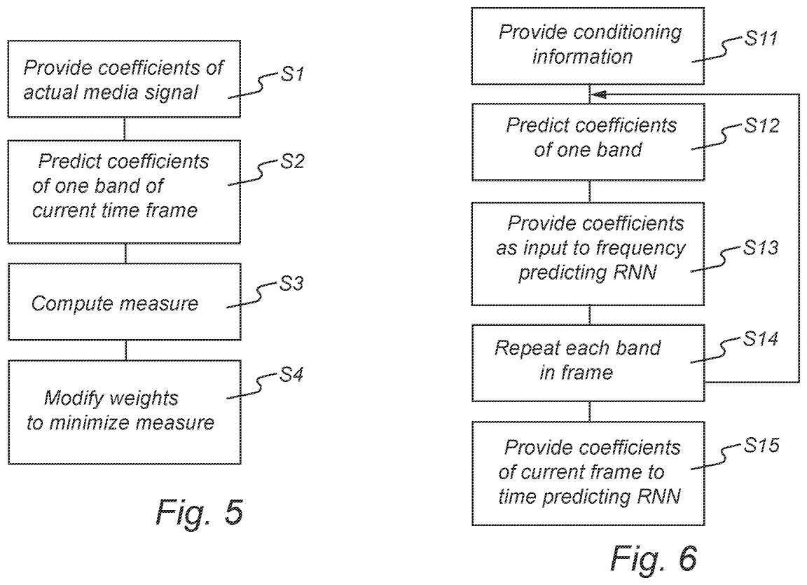

FIG. 4 shows a generative model 40 for generating a target media signal, using such a conditioned predictor. The model 40 in FIG. 4 includes a self-generating neural network system 30 according to FIG. 3, and a conditioning neural network 41.

The conditioning neural network 41 is trained to predict a set of conditioning variables given conditioning information 42 describing the target media signal. The conditioning network 41 is here a 2-D convolutional neural network with a 2-D kernel (frequency direction and time direction).

In the illustrated case the conditioning information 42 is two-channel and includes quantized frequency coefficients and a set of perceptual model coefficients. The quantized frequency coefficients \tilde{X}_{t . . . t+n} represent a time frame t of the target media signal, and n look-ahead frames. The set of perceptual model coefficients pEnvQ may be derived from a perceptual model, such as those occurring in audio codec systems. The perceptual model coefficients pEnvQ are computed per band and are preferably mapped onto the same resolution as the frequency coefficients to facilitate processing.

In the illustrated embodiment, the conditioning network is configured to concatenate \tilde{X}_{t . . . t+n} and pEnvQ, and the conditioning network 41 is configured to take the concatenated input and provide an output with a dimension which is two times the internal dimension of the neural network system 30 (e.g. 2×1024 in the present example). A splitter 43 is arranged to split the “double-length” output channel along the feature channel dimension. One half of the output variables is added with the input variables connected to the time predicting recurrent neural network 13. The second half of the output variables is added to the input variables connected to the frequency predicting recurrent network 19. It has been empirically shown that splitting operation helps overall optimization performance.

Alternatively, the conditioning network 41 is configured to operate in the same dimension as the predictor 40, and outputs only 1024 output variables. In that case, no splitter is required, and the same conditioning variables are provided to both recurrent neural networks 13, 19.

Again with reference to FIG. 5, training of the generative model 40 can also be done in “teacher forcing mode”. First, in step S1, ground truth frequency coefficients representing an “actual” (known) media signal are provided as conditioning information to the conditioning network 41. In this case, the frequency coefficients are first quantized, or otherwise distorted, in the same way as they would be in the actual implementation. The probability distributions of the bins X̅ₜ(b) of a current time frame are then predicted in step S2. In step S3, the predicted bins X̅ₜ(b) are compared to the actual bins Xₜ(b) of the actual signal in order to determine a training measure. Finally, in step S4, the parameters (weights and bias) of the various neural networks 11, 13, 15, 18, 19, 21, 22 and 41 are chosen such that the training measure is minimized. As an example, the training measure which should be minimized may be the negative log-likelihood (NLL), e.g. in the case of Laplace distribution:

$$N L L = log ( 2 * s ) + \frac{\vert μ - y \vert}{s} , \qquad ( 2 )$$

where μ and s are the model output predictions and y is the actual bin value. The NLL would look slightly different in case of a Gaussian or mixture distribution model.

The generative model 40 may advantageously be implemented in a decoder, e.g. in order to enhance a quantized (or otherwise distorted) input signal.

Specifically, decoding performance may be improved with the same amount or even reduced amount of coding parameters. For example, spectral voids in the input signal may be filled by the neural network. As mentioned, the generative model may operate in the transform domain, which may be particularly useful in a decoder.

In use, the generative model 40 operates as illustrated in FIG. 6. First, in step S11, conditioning information, e.g. a set of quantized frequency coefficients and perceptual model data received by a decoder, is provided to the conditioning network 41. Then, in step S12 and S13, frequency coefficients X̅ₜ(b) of a specific band b of a current frame t are predicted and provided as input to the frequency predicting RNN 19. In step S14, steps S12 and S13 are repeated for each frequency band in the current frame. In step S15, predicted frequency coefficients of an entire frame X̅ₜ are provided to the time predicting RNN 13, thereby enabling continued prediction of the next frame.

In the above, possible methods of training and operating a deep-learning-based system for determining an indication of an audio quality of an input audio sample, as well as possible implementations of such system have been described. Additionally, the present disclosure also relates to an apparatus for carrying out these methods. An example of such apparatus may comprise a processor (e.g., a central processing unit (CPU), a graphics processing unit (GPU), a digital signal processor (DSP), one or more application specific integrated circuits (ASICs), one or more radio-frequency integrated circuits (RFICs), or any combination of these) and a memory coupled to the processor. The processor may be adapted to carry out some or all of the steps of the methods described throughout the disclosure.

The apparatus may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that apparatus. Further, the present disclosure shall relate to any collection of apparatus that individually or jointly execute instructions to perform any one or more of the methodologies discussed herein.

The present disclosure further relates to a program (e.g., computer program) comprising instructions that, when executed by a processor, cause the processor to carry out some or all of the steps of the methods described herein.

Yet further, the present disclosure relates to a computer-readable (or machine-readable) storage medium storing the aforementioned program. Here, the term “computer-readable storage medium” includes, but is not be limited to, data repositories in the form of solid-state memories, optical media, and magnetic media, for example.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one example embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The processing system may also encompass a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one or more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code. Furthermore, a computer-readable carrier medium may form, or be included in a computer program product.

In alternative example embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a Personal Digital Assistant (PDA), a cellular telephone, a web appliance, a network router, switch or bridge, or any machine capable of executing a set of instructions (sequential or otherwise) that specify actions to be taken by that machine.

Note that the term “machine” shall also be taken to include any collection of machines that individually or jointly execute a set (or multiple sets) of instructions to perform any one or more of the methodologies discussed herein.

Thus, one example embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, example embodiments of the present disclosure may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present disclosure may take the form of a method, an entirely hardware example embodiment, an entirely software example embodiment or an example embodiment combining software and hardware aspects. Furthermore, the present disclosure may take the form of carrier medium (e.g., a computer program product on a computer-readable storage medium) carrying computer-readable program code embodied in the medium.

The software may further be transmitted or received over a network via a network interface device. While the carrier medium is in an example embodiment a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present disclosure. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media may also take the form of acoustic or light waves, such as those generated during radio wave and infrared data communications. For example, the term “carrier medium” shall accordingly be taken to include, but not be limited to, solid-state memories, a computer product embodied in optical and magnetic media; a medium bearing a propagated signal detectable by at least one processor or one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one example embodiment by an appropriate processor (or processors) of a processing (e.g., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Reference throughout this disclosure to “one example embodiment”, “some example embodiments” or “an example embodiment” means that a particular feature, structure or characteristic described in connection with the example embodiment is included in at least one example embodiment of the present disclosure. Thus, appearances of the phrases “in one example embodiment”, “in some example embodiments” or “in an example embodiment” in various places throughout this disclosure are not necessarily all referring to the same example embodiment. Furthermore, the particular features, structures or characteristics may be combined in any suitable manner, as would be apparent to one of ordinary skill in the art from this disclosure, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the disclosure, various features of the disclosure are sometimes grouped together in a single example embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this disclosure.

Furthermore, while some example embodiments described herein include some but not other features included in other example embodiments, combinations of features of different example embodiments are meant to be within the scope of the disclosure, and form different example embodiments, as would be understood by those skilled in the art. For example, in the following claims, any of the claimed example embodiments can be used in any combination.

In the description provided herein, numerous specific details are set forth. However, it is understood that example embodiments of the disclosure may be practiced without these specific details. In other instances, well-known methods, structures and techniques have not been shown in detail in order not to obscure an understanding of this description.

Thus, while there has been described what are believed to be the best modes of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure. In particular, different layouts may be contemplated for realizing the high level predictor structure in FIG. 1a.

Various aspects of the present invention may be appreciated from the following list of enumerated exemplary embodiments (EEEs).

EEE1. A computer implemented neural network system for predicting frequency coefficients of a media signal, the neural network system comprising:
a time predicting portion including at least one neural network trained to predict a first set of output variables representing a specific frequency band of a current time frame given coefficients of one or several previous time frames, and
a frequency predicting portion including at least one neural network trained to predict a second set of output variables representing a specific frequency band given coefficients of one or several frequency bands adjacent to the specific frequency band in said current time frame,
an output stage configured to provide a set of frequency coefficients representing said specific frequency band of said current time frame, based on said first and second set of output variables.

EEE2. The neural network system according to claim EEE1, wherein said first set of output variables, predicted by the time predicting portion, are used as input variables to the frequency predicting portion.

EEE3. The neural network system according to EEE2, wherein the time predicting portion includes:
a time predicting recurrent neural network comprising a plurality of neural network layers, said time predicting recurrent neural network being trained to predict an intermediate set of output variables representing the current time frame, given a first set of input variables representing a preceding time frame of the media signal.

EEE4. The neural network system according to EEE3, wherein the time predicting portion further includes:
an input stage comprising a neural network trained to predict said first set of input variables given frequency coefficients of a preceding time frame of said media signal.

EEE5. The neural network system according to EEE4, wherein the time predicting portion further includes:
a band mixing neural network trained to predict said first set of output variables, wherein variables in the intermediate set are formed by mixing variables in said intermediate set representing said specific frequency band and a plurality of neighboring frequency bands.

EEE6. The neural network system according to EEE5, wherein the frequency predicting portion includes:
a frequency predicting recurrent neural network comprising a plurality of neural network layers, said frequency predicting neural network being trained to predict said second set of output variables, given a sum of said first set of output variables and a second set of input variables representing lower frequency bands of the current time frame.

EEE7. The neural network system according to EEE6, wherein the frequency predicting portion further includes:
one or several output layers trained to provide said set of frequency coefficients based on said second set of output variables.

EEE8. The neural network system according to EEE1, wherein each frequency coefficient is represented by a set of distribution parameters, wherein said set of distribution parameters are configured to parametrize a probability distribution of the coefficient.

EEE9. The neural network system according to EEE8, wherein the probability distribution is one of a Laplace distribution, a Gaussian distribution, and a Logistic distribution.

EEE10. The neural network system according to EEE1, wherein the frequency coefficients correspond to bins of a time-to-frequency transform of the media signal.

EEE11. The neural network system according to EEE1, wherein the frequency coefficients correspond to samples of a filterbank representation of the media signal.

EEE12. A generative model for generating a target media signal, comprising:
a neural network system according to EEE3, and
a conditioning neural network trained to predict a set of conditioning variables given conditioning information describing the target media signal,
said time predicting recurrent neural network being configured to combine said first set of input variables with at least a subset of said set of conditioning variables.

EEE13. The generative model according to EEE12, wherein the neural network system includes a frequency predicting recurrent neural network according to EEE6, and wherein
said frequency predicting recurrent neural network is configured to combine said sum with at least a subset of said set of conditioning variables.

EEE14. The generative model according to EEE13, wherein the set of conditioning variables includes twice as many variables as an internal dimension of the neural network system, and wherein said time predicting recurrent neural network and said frequency predicting recurrent neural network each are supplied with one half of the conditioning variables.

EEE15. The generative model according to EEE12, wherein the conditioning information includes a set of distorted frequency coefficients.

EEE16. The generative model according to EEE15, wherein the conditioning information additionally includes a set of perceptual model coefficients.

EEE17. The generative model according to EEE12, wherein the conditioning information includes a spectral envelope.

EEE18. The generative model according to EEE12, wherein the conditioning neural network includes a convolutional neural network with a 2D kernel operating over a frequency direction and a time direction.

EEE19. A method for training the neural network system according to EEE7, comprising the steps of:
a) providing a set of frequency coefficients representing a previous time frame of an actual media signal as said first set of input variables,
b) predicting, using the neural network system, a set of frequency coefficients representing a specific frequency band of a current time frame,
c) minimizing a measure of the predicted set of frequency coefficients with respect to a true set of frequency coefficients representing the specific frequency band of the current time frame of the actual media signal.

EEE20. The method according to EEE19, wherein each frequency coefficient is represented by a set of distribution parameters, wherein said set of distribution parameters parametrize a probability distribution of each frequency coefficient.

EEE21. The method according to EEE20, wherein the measure is a negative log-likelihood, NLL.

EEE22. A method for training the generative model according to EEE12, comprising the steps of:
a) providing a description of an actual media signal as conditioning information to the conditioning neural network,
b) predicting, using the neural network system, a set of frequency coefficients representing a specific frequency band of a current time frame,
c) minimizing a measure of the predicted set of frequency coefficients with respect to a true set of frequency coefficients representing the specific frequency band of the current time frame of the actual media signal.

EEE23. The method according to EEE22, wherein the description includes a distorted set of frequency coefficients, representing the actual media signal.

EEE24. The method according to EEE22, wherein each frequency coefficient is represented by a set of distribution parameters, wherein said set of distribution parameters parametrize a probability distribution of each frequency coefficient.

EEE25. The method according to EEE24, wherein the measure is a negative log-likelihood, NLL.

EEE26. A method for obtaining an enhanced media signal using a generative model according to EEE13, comprising the steps of:
a) providing conditioning information to the conditioning neural network,
b) for each frequency band of a current time frame, using said frequency predicting recurrent neural network to predict a set of frequency coefficients representing this frequency band, and providing said set of frequency coefficients to the frequency predicting recurrent neural network as said second set of input variables,
c) providing the predicted sets of frequency coefficients representing all frequency bands of the current frame to the time predicting RNN as said first set of input variables.

EEE27. The method according to EEE26, wherein the conditioning information includes a distorted set of frequency coefficients, representing the actual media signal.

EEE28. The method according to EEE26, wherein each frequency coefficient is represented by a set of distribution parameters, wherein said set of distribution parameters parametrize a probability distribution of each frequency coefficient, the method further comprising:
sampling each probability distribution to obtain frequency coefficient values.

EEE29. A decoder comprising a generative model according to EEE12.

EEE30. A computer program product comprising computer readable program code portions which, when executed by a computer, implement a neural network system according to EEE12.

1-15. (canceled)

16. A computer implemented neural network system for predicting frequency coefficients of a media signal, the neural network system comprising:
a time predicting portion including at least one neural network trained to predict a first set of output variables representing a time predicted frequency band of a current time frame given coefficients of one or several previous time frames, and
a frequency predicting portion including at least one neural network trained to predict a second set of output variables representing a frequency predicted frequency band given coefficients of one or several adjacent lower and, by the frequency predicting portion previously predicted, frequency bands in said current time frame,
an output stage configured to provide a set of frequency coefficients representing a specific frequency band of said current time frame, based on said first and second set of output variables, said specific frequency band being at least one of the time predicted and frequency predicted frequency band,
and wherein
a) said first set of output variables, predicted by the time predicting portion, is used as input variables to the frequency predicting portion, or
b) said second set of output variables, predicted by the frequency prediction portion, is used as input variables to the time predicting portion.

17. The neural network system according to claim 16, wherein
a) said first set of output variables, predicted by the time predicting portion, is used as input variables to the frequency predicting portion, and
said time predicted frequency band is adjacent to said frequency predicted frequency band in said current time frame.

18. The neural network system according to claim 16, wherein
b) said second set of output variables, predicted by the frequency prediction portion, is used as input variables to the time predicting portion, and
said time predicted frequency band and said frequency predicted frequency band are a same frequency band in a previous time frame and current time frame respectively.

19. The neural network system according to claim 16, wherein said first set of output variables, predicted by the time predicting portion, are used as input variables to the frequency predicting portion.

20. The neural network system according claim 16, wherein the time predicting portion includes:
a time predicting recurrent neural network comprising a plurality of neural network layers, said time predicting recurrent neural network being trained to predict an intermediate set of output variables representing the current time frame, given a first set of input variables representing a preceding time frame of the media signal, and
a band mixing neural network trained to predict said first set of output variables, wherein variables in the intermediate set are formed by mixing variables in said intermediate set representing said time predicted frequency band and a plurality of neighboring frequency bands.

21. The neural network system according to claim 20, wherein the time predicting portion further includes:
an input stage comprising a neural network trained to predict said first set of input variables given frequency coefficients of a preceding time frame of said media signal.

22. The neural network system according to claim 19, wherein the frequency predicting portion includes:
a frequency predicting recurrent neural network comprising a plurality of neural network layers, said frequency predicting neural network being trained to predict said second set of output variables, given a sum of said first set of output variables and a second set of input variables representing lower frequency bands of the current time frame.

23. The neural network system according to claim 22, wherein the frequency predicting portion further includes:
one or several output layers trained to provide said set of frequency coefficients based on said second set of output variables.

24. The neural network system according to claim 16, wherein each frequency coefficient is represented by a set of distribution parameters, wherein said set of distribution parameters are configured to parametrize a probability distribution of the coefficient,
wherein said specific frequency band of said current time frame is obtained by sampling the probability distribution of each frequency coefficient.

25. The neural network system according to claim 16, wherein the frequency coefficients correspond to bins of a time-to-frequency transform of the media signal, or the frequency coefficients correspond to samples of a filterbank representation of the media signal.

26. A generative model for generating a target media signal, comprising:
a neural network system according to claim 20, and
a conditioning neural network trained to predict a set of conditioning variables given conditioning information describing the target media signal, the conditioning information comprising quantized frequency coefficients describing the target media signal,
said time predicting recurrent neural network being configured to combine said first set of input variables with at least a subset of said set of conditioning variables.

27. The generative model according to claim 26, wherein said first set of output variables, predicted by the time predicting portion, are used as input variables to the frequency predicting portion,
wherein the neural network system includes a frequency predicting recurrent neural network comprising a plurality of neural network layers, said frequency predicting neural network being trained to predict said second set of output variables, given a sum of said first set of output variables and a second set of input variables representing lower frequency bands of the current time frame, and wherein
said frequency predicting recurrent neural network is configured to combine said sum with at least a subset of said set of conditioning variables.

28. The generative model according to claim 26, wherein the conditioning information includes at least one of a set of distorted frequency coefficients, a set of perceptual model coefficients, and a spectral envelope.

29. A method for obtaining an enhanced media signal using a generative model according to claim 26, comprising the steps of:
a) providing conditioning information to the conditioning neural network,
b) for each frequency band of a current time frame, using said frequency predicting recurrent neural network to predict a set of frequency coefficients representing this frequency band, and providing said set of frequency coefficients to the frequency predicting recurrent neural network as said second set of input variables,
c) providing the predicted sets of frequency coefficients representing all frequency bands of the current frame to the time predicting RNN as said first set of input variables.

30. A decoder comprising a generative model according to claim 26.

31. A computer program product comprising computer readable program code portions which, when executed by a computer, implement a generative model according to claim 26.
